(19) United States
(12) Patent Application Publication
(10) Pub. No.: US 2020/0409476 A1
(43) Pub. Date: Dec. 31, 2020

(54) COMPUTER MOUSE WITH INTEGRATED JOYSTICK

(71) Applicant: CLIFF MATTHIEU, Wallington, NJ (US)

(72) Inventor: CLIFF MATTHIEU, Wallington, NJ (US)

(21) Appl. No.: 16/451,246

(22) Filed: Jun. 25, 2019

(51) Int. Cl. G06F 3/0338; G06F 3/0354

(52) U.S. Cl. CPC G06F 3/0338; G06F 3/03543

(57) ABSTRACT

The computer mouse with integrated joystick is a computer interface device. The computer mouse with integrated joystick is an interface device. The computer mouse with integrated joystick: a) changes the position of a cursor on a display device associated with the computer; b) indicates to the computer to initiate an action. The computer mouse with integrated joystick comprises a pointing device and a plurality of enhancements. The pointing device is a standard mouse that has the scrolling device removed. The plurality of enhancements provide the ability to customize the actions initiated on the computer. The plurality of enhancements further improve the ability to change the position of the cursor on the display device associated with the computer.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of electric digital processing including input arrangements for transferring data into a computer through a pointing device, more specifically, a mouse configured for use with a computer. (G06F3/03543)

This disclosure addresses enhancements to a pointing device commonly referred to as a mouse. The mouse is defined in greater detail elsewhere in this disclosure. This disclosure will describe the proposed enhancements relative to a “standard” mouse. The standard mouse comprises the position sensing device, the left switch, the right switch, and the scrolling device as they are described in the definition provided elsewhere in this disclosure. This disclosure will refer to the left switch as the left primary switch and the right switch as the right primary switch.

### SUMMARY OF INVENTION

The computer mouse with integrated joystick is a computer interface device. The computer mouse with integrated joystick is configured for use with a computer. The computer mouse with integrated joystick is an interface device. The computer mouse with integrated joystick: a) changes the position of a cursor on a display device associated with the computer; b) indicates to the computer to initiate an action. The computer mouse with integrated joystick comprises a pointing device and a plurality of enhancements. The pointing device is a standard mouse that has the scrolling device removed. The plurality of enhancements provide the ability to customize the actions initiated on the computer. The plurality of enhancements further extend the ability to change the position of the cursor on the display device associated with the computer. The computer, the cursor, the display device, the standard mouse, and the scrolling device are defined elsewhere in this disclosure.

These together with additional objects, features and advantages of the computer mouse with integrated joystick will be readily apparent to those of ordinary skill in the art upon reading the following detailed description of the presently preferred, but nonetheless illustrative, embodiments when taken in conjunction with the accompanying drawings.

In this respect, before explaining the current embodiments of the computer mouse with integrated joystick in detail, it is to be understood that the computer mouse with integrated joystick is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the computer mouse with integrated joystick.

It is therefore important that the claims be regarded as including such equivalent construction insofar as they do not depart from the spirit and scope of the computer mouse with integrated joystick. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a perspective view of an embodiment of the disclosure.

FIG. 2 is a detailed view of the curser by itself.

FIG. 3 is a top view of an embodiment of the disclosure.

FIG. 4 is a side view of an embodiment of the disclosure.

FIG. 5 is a front view of an embodiment of the disclosure.

FIG. 6 is a rear view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

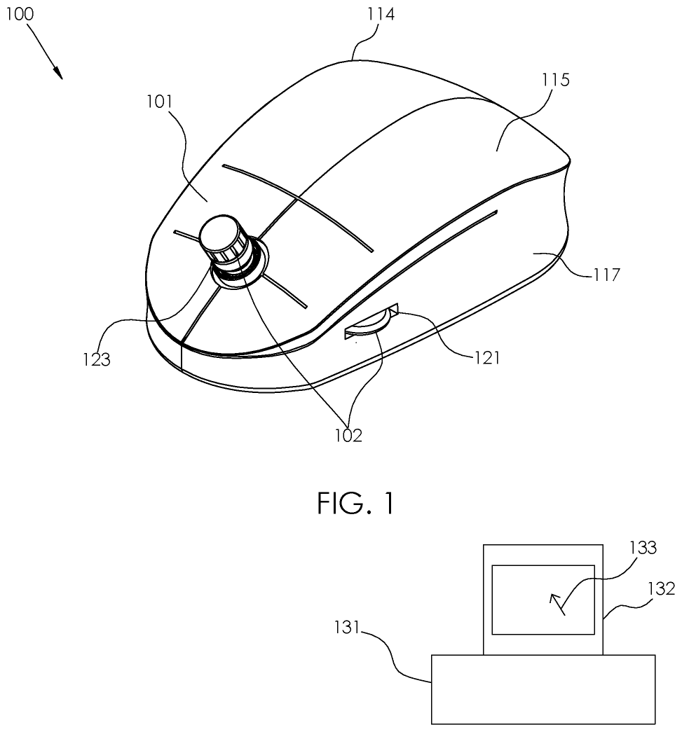

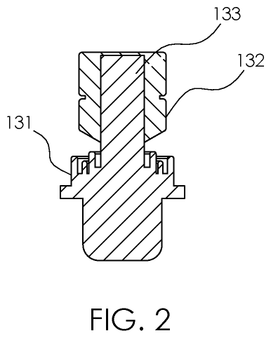

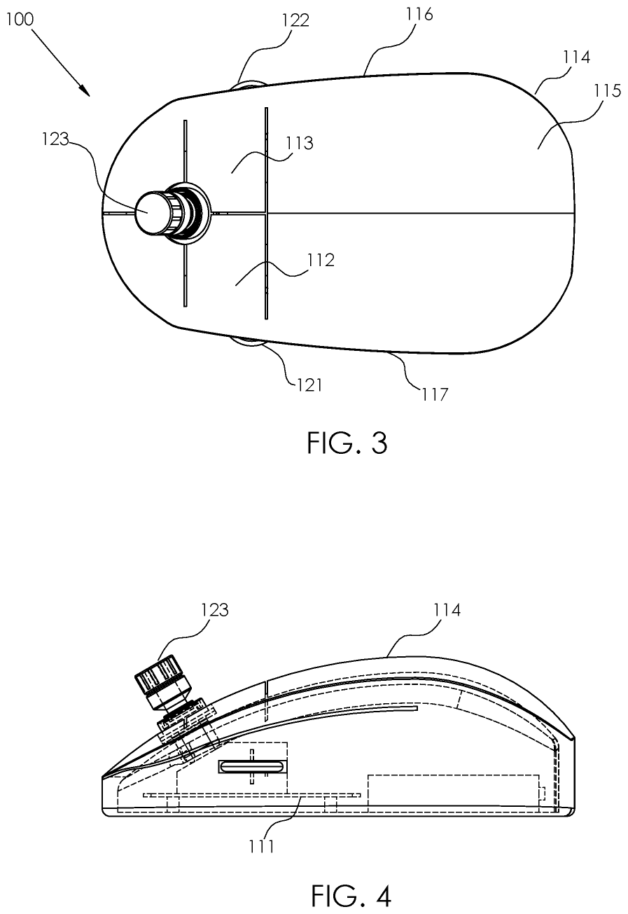

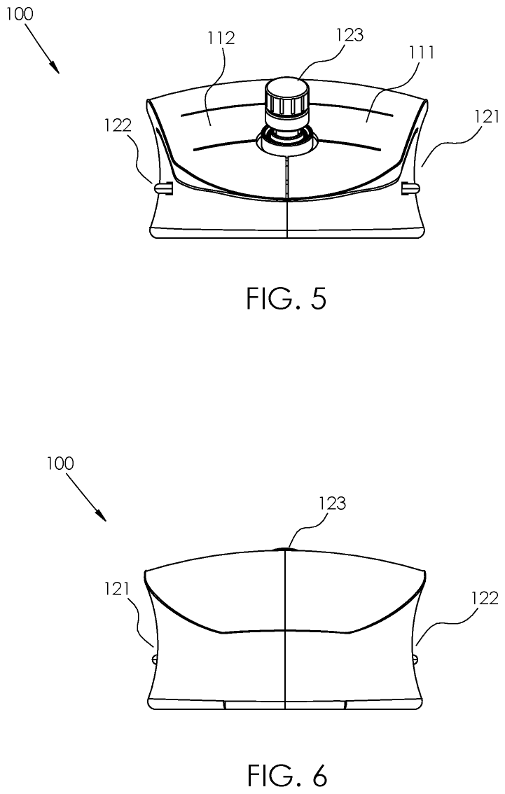

Detailed reference will now be made to one or more potential embodiments of the disclosure, which are illustrated in FIGS. 1 through 6.

The computer mouse with integrated joystick 100 (hereinafter invention) is a computer 131 interface device. The invention 100 is configured for use with the computer 131. The invention 100 is an interface device. The invention 100: a) changes the position of a cursor 133 on a display device 132 associated with the computer 131; b) indicates to the computer 131 to initiate an action. The invention 100 comprises a pointing device 101 and a plurality of enhancements 102. The pointing device 101 is a standard mouse that has the scrolling device removed. The plurality of enhancements 102 provide the ability to customize the actions initiated on the computer 131. The plurality of enhancements 102 further enhance the ability to change the position of the cursor 133 on the display device 132 associated with the computer 131. The computer 131, the cursor 133, the display device 132, the standard mouse, and the scrolling device are defined elsewhere in this disclosure.

The pointing device 101 is a computer 131 interface device. The pointing device 101 moves the position of a cursor 133 on an image displayed by a display device 132. The pointing device 101 generates one or more electric signals that initiate the computer 131 to take an action. The pointing device 101 comprises a position sensing device 111, a left primary switch 112, a right primary switch 113, and a housing 114.

The position sensing device 111 is an electrical device. The position sensing device 111 is a sensor that detects: a) that the pointing device 101 has changed position; and, b) the distance and direction of the change of position of the pointing device 101. The position sensing device 111 transmits an electrical signal to the computer 131 indicating the direction and the distance of the change of position of the pointing device 101.

The left primary switch 112 is a momentary switch that is positioned on the superior surface 115 of the housing 114 such that the left primary switch 112 is accessible from the exterior of the housing 114. The left primary switch 112 is configured to be actuated by the index finger of a right hand when the right hand is placed on the superior surface 115 of the housing 114 of the pointing device 101. The actuation of the left primary switch 112 signals the computer 131 to initiate an action based on the location of the cursor 133 on the image displayed on the display device 132.

The right primary switch 113 is a momentary switch that is positioned on the superior surface 115 of the housing 114 such that the right primary switch 113 is accessible from the exterior of the housing 114. The right primary switch 113 is configured to be actuated by the middle finger of a right hand when the right hand is placed on the superior surface 115 of the housing 114 of the pointing device 101. The actuation of the right primary switch 113 signals the computer 131 to change the image displayed on the display device 132. The displayed image is changed such that the displayed image presents a list of options available for use. The displayed list of options is selected based on the location of the cursor 133 in the image displayed on the display device 132.

The operation and use of the left primary switch 112 and the right primary switch 113 are consistent with the operation of the left switch and the right switch of a standard computer mouse.

The housing 114 is a rigid structure. The housing 114 contains the position sensing device 111, the left primary switch 112, and the right primary switch 113, and the plurality of enhancements 102. The housing 114 is formed with all apertures and form factors necessary to allow the housing 114 to accommodate the use, the operation, and the external connections of the position sensing device 111, the left primary switch 112, and the right primary switch 113, and the plurality of enhancements 102. Methods to form a housing 114 suitable for the purposes described in this disclosure are well-known and documented in the mechanical arts. The housing 114 further comprises a superior surface 115, a right surface 116, and a left surface 117.

The superior surface 115 forms the superior structure of the housing 114. A hand is placed on the pointing device 101 such that the hand rests on the superior surface 115 of the housing 114.

The right surface 116 forms a vertical surface of the rigid structure that forms the housing 114. The right surface 116 is the surface of the housing 114 that is distal from the thumb of a right hand that is placed on the superior surface 115 of the housing 114 of the pointing device 101.

The left surface 117 forms a vertical surface of the rigid structure that forms the housing 114. The left surface 117 is the surface of the housing 114 that is proximal to the thumb of a right hand that is placed on the superior surface 115 of the housing 114 of the pointing device 101.

Each of the plurality of enhancements 102 is an electrical device. The plurality of enhancements 102 provide an alternate mechanism to move the position of a cursor 133 on an image displayed by a display device 132. The plurality of enhancements 102 provide the ability to customize the actions initiated on the computer 131. The plurality of enhancements 102 comprises a left supplemental switch 121, a right supplemental switch 122, and a joystick 123.

The left supplemental switch 121 is a momentary switch that is positioned on the left surface 117 of the housing 114 such that the left supplemental switch 121 is accessible from the exterior of the housing 114. The left supplemental switch 121 is configured to be actuated by the thumb of a right hand when the right hand is placed on the superior surface 115 of the housing 114 of the pointing device 101. The actuation of the left supplemental switch 121 signals the computer 131 to initiate a previously programmed action that may or may not be based on the location of the cursor 133 on the image displayed on the display device 132.

The right supplemental switch 122 is a momentary switch that is positioned on the right surface 116 of the housing 114 such that the right supplemental switch 122 is accessible from the exterior of the housing 114. The right supplemental switch 122 is configured to be actuated by a finger of a right hand when the right hand is placed on the superior surface 115 of the housing 114 of the pointing device 101. The finger is selected from the group consisting of the fourth finger of the right hand and the fifth finger of the right hand. The actuation of the right supplemental switch 122 signals the computer 131 to initiate a previously programmed action that may or may not be based on the location of the cursor 133 on the image displayed on the display device 132.

By previously programmed action is meant that the computer 131 should initiate an action that is commonly referred to as a keyboard command. By keyboard command is meant that the computer 131 will initiate an action that would normally be implemented through a plurality of keystrokes entered through a keyboard. In the first potential embodiment of the disclosure, the left supplemental switch 121 is programmed to implement a “cntrl+tab” key sequence that allows a user to navigate through multiple open applications operating on the computer 131. The right supplemental switch 122 is programmed to implement a “Window+tab” key sequence that allows access to the viewing history of a browser.

The joystick 123 is an electrical device. The joystick 123 is a rotating lever that generates and transmits an electrical signal to the computer 131. The electrical signal transmitted by the joystick 123 to the computer 131 indicates the position of the rotating lever of the joystick 123 relative to a reference position. The joystick 123 is positioned between the left primary switch 112 and the right primary switch 113 such that the index finger of either hand will operate the joystick 123. The relative position of the rotating lever of the joystick 123 indicates to the computer 131 the direction of motion desired for the cursor 133.

The following definitions were used in this disclosure:

Computer: As used in this disclosure, a computer is a programmable electrical device that processes externally provided inputs to generate outputs that are determined from a previously programmed set of instructions.

Cursor: As used in this disclosure, a cursor is a sub-image contained within an image displayed by a display device that that indicates a specific location within the displayed image. The location of the cursor is repositionable within the displayed image using an interface device.

Display: As used in this disclosure, a display is a surface upon which is presented an image, potentially including, but not limited to, graphic images and text, that is interpretable by an individual viewing the projected image in a meaningful manner. A display device refers to an electrical device used to present these images.

Force of Gravity: As used in this disclosure, the force of gravity refers to a vector that indicates the direction of the pull of gravity on an object at or near the surface of the earth.

Form Factor: As used in this disclosure, the term form factor refers to the size and shape of an object.

Housing: As used in this disclosure, a housing is a rigid structure that encloses and protects one or more devices.

Image: As used in this disclosure, an image is an optical representation or reproduction of an indicia or of the appearance of something or someone.

Inferior: As used in this disclosure, the term inferior refers to a directional reference that is parallel to and in the same direction as the force of gravity when an object is positioned or used normally.

Interface: As used in this disclosure, an interface is a physical or virtual boundary that separates two different systems across which information is exchanged.

Joystick: As used in this disclosure, a joystick is a computer interface device. The joystick is configured for use with a computer. The joystick is a rotating lever used to change the position of a cursor on a display device associated with the computer. The joystick sends an electrical signal to the computer that indicates how the position of a cursor should be moved within a displayed image displayed by a display device.

Keyboard: As used in this disclosure, a keyboard is a panel that further comprises a plurality of buttons that are commonly referred to as keys. The keyboard is commonly used to operate devices including, but not limited to, logical devices and musical instruments.

Lever: As used in this disclosure, a lever is a shaft that rotates around a pivot point.

Momentary Switch: As used in this disclosure, a momentary switch is a biased switch in the sense that the momentary switch has a baseline position that only changes when the momentary switch is actuated (for example when a pushbutton switch is pushed or a relay coil is energized). The momentary switch then returns to the baseline position once the actuation is completed. This baseline position is called the “normal” position. For example, a “normally open” momentary switch interrupts (open) the electric circuit in the baseline position and completes (closes) the circuit when the momentary switch is activated. Similarly, a “normally closed” momentary switch will complete (close) an electric circuit in the baseline position and interrupt (open) the circuit when the momentary switch is activated.

Mouse: As used in this disclosure, a mouse, also referred to as a computer mouse, is a computer interface device. The mouse is configured for use with a computer. The mouse: a) changes the position of a cursor on a display device associated with the computer; b) indicates to the computer to initiate an action. The initiated action depends on: a) the location of the cursor on the displayed image displayed by the display device; and, b) the specific method used on the mouse to initiate the action. The typical mouse comprises a position sensing device, a left switch (button), a right switch (button), and a scrolling device. The position sensing device detects changes in the physical position of the mouse. The position sensing device sends an electrical signal to the computer that allows the computer move the position of the mouse within the display based on the physical motion of the mouse. The left switch is an electrical switch that sends an electrical signal to the computer that indicates that the computer should take initiate an action. The selected action is a function of the location of the cursor on the displayed image. The right switch is an electrical switch that sends an electrical signal to the computer that indicates that the computer should display a list of optional actions that may be taken. The selected list of optional actions is a function of the location of the cursor on the displayed image. The scrolling device is used in circumstances where the display device forms an overlay. By forming an overlay is meant that the image displayed on the display device is only a portion of the overall image that is available for display. The use of an overlay typically is required by technical limitations or technical preferences set on the computer. The scrolling device is used to adjust the overlay position of the displayed image on the display device. The term scroll refers to the act of adjusting the position of the overlay. The mouse is often referred to as a pointing device.

Overlay: As used in this disclosure, an overlay refers to the placement of a second structure over a first structure such that a portion of the first structure is visible through the second structure.

Rigid Structure: As used in this disclosure, a rigid structure is a solid structure formed from an inelastic material that resists changes in shape. A rigid structure will permanently deform as it fails under a force.

Scroll: As used in this disclosure, the term scroll refers to an adjustment of the overlay position of a displayed image on the display device.

Superior: As used in this disclosure, the term superior refers to a directional reference that is parallel to and in the opposite direction of the force of gravity when an object is positioned or used normally.

Switch: As used in this disclosure, a switch is an electrical device that starts and stops the flow of electricity through an electric circuit by completing or interrupting an electric circuit. The act of completing or breaking the electrical circuit is called actuation. Completing or interrupting an electric circuit with a switch is often referred to as closing or opening a switch respectively. Completing or interrupting an electric circuit is also often referred to as making or breaking the circuit respectively.

With respect to the above description, it is to be realized that the optimum dimensional relationship for the various components of the invention described above and in FIGS. 1 through 6 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

The inventor claims:

1. A computer mouse with integrated joystick comprising
a pointing device and a plurality of enhancements;
wherein the plurality of enhancements mount in the pointing device;
wherein the computer mouse with integrated joystick is configured for use with a computer;
wherein the computer further comprises a display device and a cursor;
wherein the cursor is displayed on the display device;
wherein the computer mouse with integrated joystick is an interface device;
wherein the computer mouse with integrated joystick is configured to: a) change a position of a cursor on a display device associated with the computer; b) indicates to the computer to initiate an action;
wherein the plurality of enhancements comprises a left supplemental switch, a right supplemental switch, a housing, and a joystick;
wherein the joystick is a rotating lever that generates and transmits an electrical signal to the computer;
wherein the electrical signal transmitted by the joystick to the computer indicates the position of the rotating lever of the joystick relative to a reference position;
wherein the joystick is positioned between the left primary switch and the right primary switch such that the index finger of either hand will operate the joystick;
wherein the relative position of the rotating lever of the joystick indicates to the computer the direction of motion desired for the cursor;
wherein the housing further comprises a superior surface, a right surface, and a left surface;
wherein the superior surface forms the superior structure of the housing;
wherein the right surface forms a vertical surface of the rigid structure that forms the housing;
wherein the left surface forms a vertical surface of the rigid structure that forms the housing.

2. The computer mouse with integrated joystick according to claim 1
wherein each of the plurality of enhancements is an electrical device;
wherein the plurality of enhancements customize the actions initiated on the computer;
wherein the plurality of enhancements change the position of the cursor on the display device.

3. The computer mouse with integrated joystick according to claim 2
wherein the pointing device is a computer interface device;
wherein the pointing device moves the position of a cursor on an image displayed by a display device;
wherein the pointing device generates one or more electric signals that initiate the computer to take an action.

4. The computer mouse with integrated joystick according to claim 3
wherein the housing contains the position sensing device, the left primary switch, and the right primary switch, and the plurality of enhancements.

5. The computer mouse with integrated joystick according to claim 4
wherein the position sensing device is an electrical device;
wherein the position sensing device is a sensor that detects: a) that the pointing device has changed position; and, b) the distance and direction of the change of position of the pointing device.

6. The computer mouse with integrated joystick according to claim 5 wherein the position sensing device transmits an electrical signal to the computer indicating the direction and the distance of the change of position of the pointing device.

7. The computer mouse with integrated joystick according to claim 6
wherein the left primary switch is a momentary switch that is positioned on the superior surface of the housing such that the left primary switch is accessible from the exterior of the housing;
wherein the left primary switch is configured to be actuated by the index finger of a right hand when the right hand is placed on the superior surface of the housing of the pointing device.

8. The computer mouse with integrated joystick according to claim 7 wherein the actuation of the left primary switch signals the computer to initiate an action based on the location of the cursor on the image displayed on the display device.

9. The computer mouse with integrated joystick according to claim 8
wherein the actuation of the right primary switch signals the computer to change the image displayed on the display device;
wherein the displayed image is changed such that the displayed image presents a list of options available for use;
wherein the displayed list of options is selected based on the location of the cursor in the image displayed on the display device.

10. The computer mouse with integrated joystick according to claim 9 wherein the housing is a rigid structure.

11. (canceled)

12. The computer mouse with integrated joystick according to claim 10
wherein the left supplement switch is positioned on the left surface of the housing such that the left supplemental switch is accessible from the exterior of the housing;
wherein the right supplement switch is positioned on the right surface of the housing such that the right supplemental switch is accessible from the exterior of the housing.

13. The computer mouse with integrated joystick according to claim 12
wherein the left supplemental switch is a momentary switch;
wherein the actuation of the left supplemental switch signals the computer to initiate a previously programmed action.

14. The computer mouse with integrated joystick according to claim 13
wherein the right supplemental switch is a momentary switch;
wherein the actuation of the right supplemental switch signals the computer to initiate a previously programmed action.

15. The computer mouse with integrated joystick according to claim 14 wherein by previously programmed action is meant that the computer should initiate an action called a keyboard command.

16. The computer mouse with integrated joystick according to claim wherein the left supplemental switch initiates the navigation through multiple open applications operating on the computer.

17. (canceled)

18. The computer mouse with integrated joystick according to claim 3
wherein the left supplemental switch is a momentary switch;
wherein the actuation of the left supplemental switch signals the computer to initiate a previously programmed action;
wherein the right supplemental switch is a momentary switch;
wherein the actuation of the right supplemental switch signals the computer to initiate a previously programmed action;
wherein by previously programmed action is meant that the computer should initiate an action called a keyboard command.

19. The computer mouse with integrated joystick according to claim 18
wherein the left supplemental switch initiates the navigation through multiple open applications operating on the computer.

20. The computer mouse with integrated joystick according to claim 19
wherein the pointing device comprises a position sensing device, a left primary switch, a right primary switch, and a housing;
wherein the housing contains the position sensing device, the left primary switch, and the right primary switch, and the plurality of enhancements;
wherein the position sensing device is an electrical device;
wherein the position sensing device is a sensor that detects: a) that the pointing device has changed position; and, b) the distance and direction of the change of position of the pointing device;
wherein the position sensing device transmits an electrical signal to the computer indicating the direction and the distance of the change of position of the pointing device;
wherein the left primary switch is a momentary switch that is positioned on the superior surface of the housing such that the left primary switch is accessible from the exterior of the housing;
wherein the left primary switch is configured to be actuated by the index finger of a right hand when the right hand is placed on the superior surface of the housing of the pointing device;
wherein the actuation of the left primary switch signals the computer to initiate an action based on the location of the cursor on the image displayed on the display device;
wherein the actuation of the right primary switch signals the computer to change the image displayed on the display device;
wherein the displayed image is changed such that the displayed image presents a list of options available for use;
wherein the displayed list of options is selected based on the location of the cursor in the image displayed on the display device;
wherein the housing is a rigid structure;
wherein the left supplemental switch is positioned on the left surface of the housing such that the left supplemental switch is accessible from the exterior of the housing;
wherein the right supplemental switch is positioned on the right surface of the housing such that the right supplemental switch is accessible from the exterior of the housing;
wherein the joystick is positioned between the left primary switch and the right primary switch such that the index finger of either hand will operate the joystick.
